(19) United States
(12) Patent Application Publication
(10) Pub. No.: US 2005/0008546 A1
(43) Pub. Date: Jan. 13, 2005

(54) Exhaust gas treatment system

(76) Inventors: Norihisa Kobayashi, Tokyo (JP); Yoshihisa Arakawa, Tokyo (JP); Tatsuo Yokoshiki, Tokyo (JP); Naoyoshi Oda, Tokyo (JP); Toshiyuki Onishi, Nagasaki-shi (JP)

Correspondence Address: BIRCH STEWART KOLASCH & BIRCH, PO BOX 747, FALLS CHURCH, VA, 22040-0747, US

(21) Appl. No.: 10/834,945

(22) Filed: Apr. 30, 2004

(30) Foreign Application Priority Data
Jul. 7, 2003 (JP) 2003-192846

(51) Int. Cl. B01D 53/60

(52) U.S. Cl. 422/173; 422/171; 422/177; 422/172

(57) ABSTRACT

In an exhaust gas treatment system, dust in a high temperature exhaust gas is caught by a high temperature dry electrostatic precipitator, a nitrogen oxide NO₂ in the exhaust gas is removed by denitration means, then the exhaust gas is cooled by an air heater, and the exhaust gas is passed through an activated carbon fiber layer of activated carbon treatment means to remove sulfur oxides SO₂ and SO₃ contained in the exhaust gas. The exhaust gas treatment system reduces the costs of treatment and equipment, and downsizes the system.

The entire disclosure of Japanese Patent Application No. 2003-192846 filed on Jul. 7, 2003, including specification, claims, drawings and summary, is incorporated herein by reference in its entirety.

### BACKGROUND OF THE INVENTION

1. Field of the Invention

This invention relates to an exhaust gas treatment system for purifying a high temperature exhaust gas discharged from a boiler plant or the like which uses a high sulfur content fuel.

2. Description of the Related Art

FIG. 3 schematically shows the configuration of a conventional exhaust gas treatment system. As shown in FIG. 3, the conventional exhaust gas treatment system is composed of a denitration device 002, an air heater 003, a dry electrostatic precipitator 004, a suction fan 005, a desulfurization device 006, a wet electrostatic precipitator 007, and a smokestack 008 arranged successively with respect to an exhaust gas discharged from a boiler 001.

Thus, the exhaust gas discharged from the boiler 001 is admitted to the denitration device 002, where ammonia is added to nitrogen oxides in the exhaust to carry out denitration. Then, the denitrated exhaust gas is cooled in the air heater 003 to a predetermined temperature or lower, and is then sent to the dry electrostatic precipitator 004. In the dry electrostatic precipitator 004, ammonia is added to dust in the exhaust gas and a sulfur oxide (SO₃) in the exhaust gas to form fine particles comprising ammonium sulfate, which are then attracted and removed. After the exhaust gas is sucked by the suction fan 005, the exhaust gas is humidified and cooled, and then flowed through the desulfurization device 006, where a sulfur oxide (SO₂) in the exhaust gas is adsorbed to and removed by limestone. Then, the exhaust gas is fed to the wet electrostatic precipitator 007, where fine particles of the sulfur oxide (SO₃) remaining in the exhaust gas are attracted and removed. Finally, the exhaust gas is released to the atmosphere through the smokestack 008.

Such a conventional exhaust gas treatment system is disclosed, for example, in Japanese Patent No. 3272366.

With the above-described boiler plant, there have been attempts to reduce fuel costs by use of inexpensive fuels. In recent years, however, emphasis has tended to be placed on environmental problems. The necessity has arisen for treating nitrogen oxides and sulfur oxides in the exhaust gas at an even higher level, even with the use of inexpensive fuel.

In the aforementioned conventional exhaust gas treatment system, however, the content of sulfur trioxide (SO₃) in the exhaust gas is high. In the dry electrostatic precipitator 004, therefore, the sulfur trioxide is attracted and removed in the form of ammonium sulfate by addition of ammonia thereto. This poses the problem that a large amount of ammonia is required, increasing the cost of treatment. Moreover, the dry electrostatic precipitator 004 is intrinsically intended to attract dust in the exhaust gas, but since it has to attract a large amount of ammonium sulfate, it may be unable to attract and remove dust sufficiently.

Furthermore, not all of sulfur trioxide in the exhaust gas can be removed by the dry electrostatic precipitator 004. The desulfurization device 006, on the other hand, is designed to adsorb and remove sulfur dioxide (SO₂) in the exhaust. Downstream from the desulfurization device 006, the wet electrostatic precipitator 007 is disposed for attracting and removing sulfur trioxide remaining in the exhaust gas. Thus, the two electrostatic precipitators, 004 and 007, are needed, presenting the problem that the system is upsized and the equipment costs are increased.

### SUMMARY OF THE INVENTION

The present invention has been accomplished to solve the above-described problems. It is the object of the invention to provide an exhaust gas treatment system intended to decrease the costs of treatment and equipment and downsize the system.

According to the present invention, intended for attaining the above object, there is provided an exhaust gas treatment system comprising: an electrostatic precipitator for catching fine particles in a high temperature exhaust gas; a heat exchanger provided downstream from the electrostatic precipitator; and activated carbon treatment means for passing therethrough the exhaust gas, which has been cooled to a predetermined temperature or lower upon heat exchange by the heat exchanger after catching of the fine particles by the electrostatic precipitator, to remove sulfur oxides by an activated carbon fiber layer.

According to this feature, the activated carbon treatment means reliably removes sulfur oxides in the exhaust gas. Thus, it is not necessary to add ammonia to the exhaust gas, thereby converting sulfur trioxide into ammonium sulfate, and to remove the resulting ammonium sulfate by the electrostatic precipitator. Since ammonia for desulfurization treatment is not required, the cost of treatment can be decreased. Moreover, dust in the exhaust gas can be reliably attracted and removed by the electrostatic precipitator. Furthermore, sulfur dioxide and sulfur trioxide in the exhaust gas can be removed by the activated carbon treatment means, thus obviating the need for a wet electrostatic precipitator, and making downsizing and compactness of the system possible.

In the exhaust gas treatment system, denitration means for treating nitrogen oxides in the exhaust gas may be provided between the electrostatic precipitator and the activated carbon treatment means. Thus, an influx of dust and trace metal elements into the denitration means can be decreased to prevent their deposition on the denitration means, and compactness of the electrostatic precipitator and the denitration means can be achieved.

In the exhaust gas treatment system, the denitration means may comprise a first denitration catalyst layer, an ammonia decomposing catalyst layer, and a second denitration catalyst layer disposed in a direction of flow, and the denitration means may be an ammonia decomposing denitration catalyst which adds ammonia, in an amount not smaller than an ammonia-reactive amount of the nitrogen oxides in the exhaust gas, to an entrance to the first denitration catalyst layer. Thus, acidic ammonium sulfate, which is formed from sulfur oxides in the exhaust gas and residual ammonia, can be decreased markedly.

In the exhaust gas treatment system, the electrostatic precipitator may be a high temperature dry electrostatic precipitator for catching the fine particles in the high temperature exhaust gas at 200° C. or higher. Thus, after fine particles of dust contained in the high temperature exhaust gas are removed, denitration and desulfurization are performed. That is, the treatments for removing nitrogen oxides and sulfur oxides in the exhaust gas are performed in a situation where virtually no dust exists in the exhaust gas. Hence, the efficiency of the treatments can be increased.

In the exhaust gas treatment system, the high temperature exhaust gas may be an exhaust gas discharged from a boiler plant using a fuel having a high sulfur content. Thus, a large amount of sulfur contained in the exhaust gas can be removed reliably.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic configuration diagram of an exhaust gas treatment system according to an embodiment of the present invention;

FIG. 2 is a schematic view of an ACF desulfurization device; and

FIG. 3 is a schematic configuration diagram of a conventional exhaust gas treatment system.

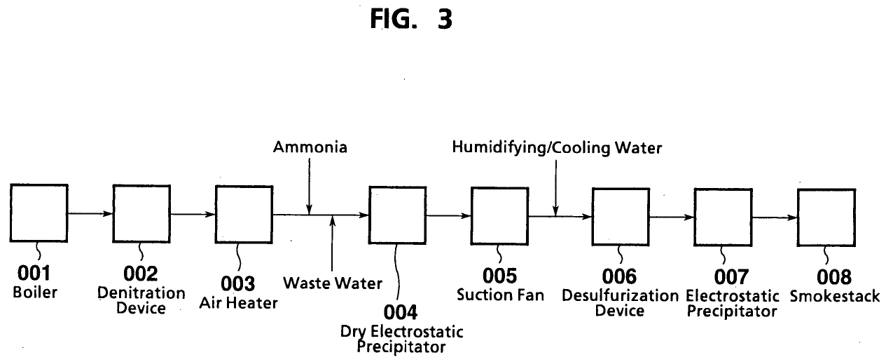

### DETAILED DESCRIPTION OF THE PREFERRED EMBODIMENTS

An embodiment of the present invention will now be described in detail with reference to the accompanying drawings.

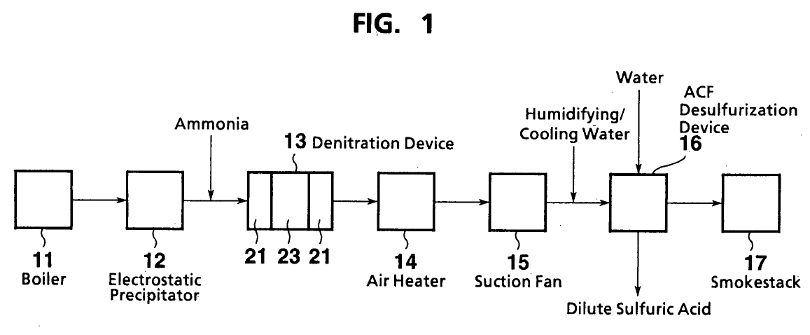

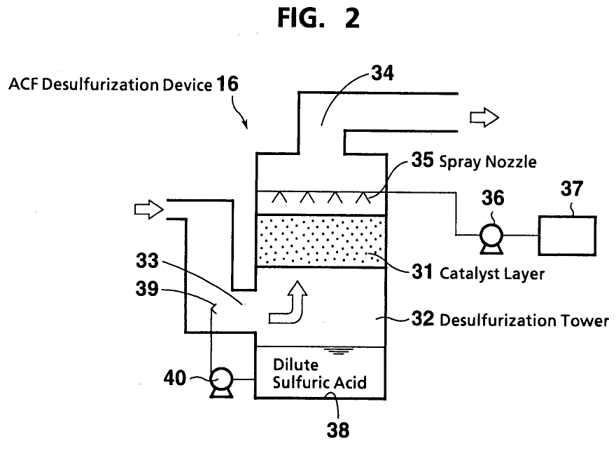

FIG. 1 schematically shows the configuration of an exhaust gas treatment system according to an embodiment of the present invention. FIG. 2 schematically shows an ACF desulfurization device.

The exhaust gas treatment system of the present embodiment is used in a boiler plant (baking furnace, incinerator, etc.) which uses a fuel containing high sulfur components such as petroleum coke and Orimulsion.

As shown in FIG. 1, the exhaust gas treatment system of the present embodiment is composed of a high temperature dry electrostatic precipitator 12, a denitration device 13, an air heater 14, a suction fan 15, an ACF desulfurization device 16, and a smokestack 17 arranged successively with respect to an exhaust gas discharged from a boiler 11.

The exhaust gas at about 200 to 400° C. is supplied from the boiler 11 to the electrostatic precipitator 12. The high temperature dry electrostatic precipitator 12 applies a high voltage between an electric discharge electrode and a dust collecting electrode to generate ions by corona discharge, thereby attracting and depositing charged fine particles in the exhaust gas onto the dust collecting electrode by their electric force. Dust deposited on the dust collecting electrode is peeled off, for disposal, by the impact force of hammering done at predetermined time intervals.

The denitration device 13 has a first denitration catalyst layer 21 and a second denitration catalyst layer 22 provided in the direction of flow, and has an ammonia decomposing catalyst layer 23 provided between the first denitration catalyst layer 21 and the second denitration catalyst layer 22. This denitration device 13 serves as an ammonia decomposing denitration catalyst for adding ammonia (NH₃), in an amount not smaller than an ammonia-reactive amount of nitrogen oxides (NOₓ) in the exhaust gas, to the entrance of the first denitration catalyst layer 21.

Thus, ammonia in the amount not smaller than the ammonia-reactive amount of nitrogen oxides is added to the first denitration catalyst layer 21 to carry out 90% or more of denitration in the first denitration catalyst layer 21. The unreacted ammonia flowing out of the first denitration catalyst layer 21 is decomposed in the ammonia decomposing catalyst layer 23 to adjust the nitrogen oxide concentration and the ammonia concentration at the entrance to the second denitration catalyst layer 22 located downstream from the ammonia decomposing catalyst layer 23. As a result, nitrogen oxides and ammonia can be decreased to 1 ppm or less at the exit of the second denitration catalyst layer 22.

In this case, if the proportion (mole ratio) of ammonia to nitrogen oxides contained in the exhaust gas is rendered higher than 1, it is known that the concentration of nitrogen oxides on the exit side can be lowered, and the concentration of ammonia on the exit side is close to 0. Thus, ammonia in the amount which is not smaller than the ammonia-reactive amount of nitrogen oxides is added to the first denitration catalyst layer 21, whereby nitrogen oxides and ammonia can be decreased to low levels (1 ppm or less).

The air heater 14 is a heat exchanger where heat exchange is performed between the high temperature exhaust gas and, for example, a low temperature exhaust gas delivered from the ACF desulfurization device 16, whereby the high temperature exhaust gas discharged from the denitration device 13 can be cooled and supplied, as a low temperature exhaust gas, to the ACF desulfurization device 16. The suction fan 15 is adapted to draw in the exhaust gas, formed by combustion in the boiler 11, toward the exhaust gas treatment system. The line covering this range is brought to a negative pressure, so that leakage to the outside can be prevented.

The ACF desulfurization device 16 is activated carbon treatment means having an activated carbon fiber layer as a catalyst. The ACF desulfurization device 16 is adapted to remove dust, sulfur oxides (SO₂, SO₃) and trace metal elements, and recover them as sulfuric acid (H₂SO₄), and is capable of suppressing emissions of fumes and toxic metal substances.

As shown in FIG. 2, the ACF desulfurization device 16 has a desulfurization tower 32 housing a catalyst layer 31 formed of an activated carbon fiber layer, has an exhaust gas inlet 33 provided at a lower portion of the desulfurization tower 32, and has an exhaust gas outlet 34 provided at the top of the desulfurization tower 32. Spray nozzles 35 for spraying water for formation of sulfuric acid are provided above the catalyst layer 31, and a water tank 37 is connected to the spray nozzles 35 via a water feed pump 36. A reservoir 38 for storing the resulting dilute sulfuric acid (sulfuric acid) is provided below the catalyst layer 31, and a jet nozzle 39 is provided for jetting this dilute sulfuric acid at the entrance to the desulfurization tower 32 to humidify and cool the exhaust gas. The jet nozzle 39 is connected to the reservoir 38 via a water feed pump 40.

Since the exhaust gas is thus humidified and cooled upon supply of dilute sulfuric acid, it becomes saturated (for example, 50° C.) and enters the desulfurization tower 32 through the inlet 33. Then, the exhaust gas passes upward through the catalyst layer 31 sprayed with industrial water by the spray nozzles 35, whereby sulfur oxides (SOₓ) in the exhaust gas can be reacted and removed. The exhaust gas that has passed through the catalyst layer 31 is let out through the outlet 34.

On this occasion, a desulfurization reaction occurs on the surface of the catalyst layer 31, as the activated carbon fiber layer, for example, in accordance with the following reactions:
(1) Adsorption of sulfur dioxide SO₂ to the activated carbon fiber layer constituting the catalyst layer 31
(2) Reaction of the adsorbed sulfur dioxide SO₂ with oxygen O₂ in the exhaust gas (O₂ can be supplied separately) to cause oxidation into sulfur trioxide SO₃
(3) Dissolution of sulfur trioxide SO₃, formed by oxidation, into water H₂O to form sulfuric acid H₂SO₄
(4) Liberation of the resulting sulfuric acid H₂SO₄ from the activated carbon fiber layer That is, the following reaction scheme holds:
   SO₂+1/2O₂+H₂O→H₂SO₄

The sulfuric acid H₂SO₄ formed by the above desulfurization treatment is used unchanged, or is subjected to treatment in which a lime slurry is supplied to precipitate gypsum.

The method of treating the exhaust gas by the exhaust gas treatment system of the present embodiment constituted as above will be described in detail.

As shown in FIG. 1, when the suction fan 15 is operated, the exhaust line for the exhaust gas after combustion in the boiler 11 becomes negative in pressure. Thus, the exhaust gas is treated without leaking to the outside. That is, the exhaust gas discharged from the boiler 11 is not cooled, but remains hot, for example, at a temperature of 200 to 300° C., and is fed in this state to the high temperature, dry electrostatic precipitator 12, where fine particles of dust in the exhaust gas are attracted and removed. The exhaust gas, deprived of the fine particles of dust, is supplied to the denitration device 13, where ammonia in an amount not small than an ammonia-reactive amount of nitrogen oxides is added for denitration treatment. As a result, nitrogen oxides and ammonia are decreased to low levels.

The exhaust gas, which has been rid of dust in the high temperature dry electrostatic precipitator 12 and rid of nitrogen oxides in the denitration device 13, is cooled to a predetermined temperature (for example, 150° C.) or lower by the air heater 14, and then introduced into the ACF desulfurization device 16. In the ACF desulfurization device 16, the exhaust gas is humidified and cooled with dilute sulfuric acid, and introduced in the resulting saturated state into the desulfurization tower 32 through the inlet 33. In the desulfurization tower 32, the exhaust gas passes through the catalyst layer 31 sprayed with industrial water by the spray nozzles 35, whereby dust, sulfur dioxide SO₂, sulfur trioxide SO₃, and trace metal elements in the exhaust gas are reacted and removed.

The exhaust gas, from which dust, sulfur oxides and trace metal elements have been removed, is delivered to the outside through the outlet 34, and released to the atmosphere through the smokestack 17.

Dilute sulfuric acid, which has been removed upon reaction in the ACF desulfurization device 16, is used unchanged for the purpose of humidification and cooling, or is supplied with a lime slurry to precipitate gypsum, which can be recycled as a gypsum board. In this case, acidic ammonium sulfate, which is formed from sulfur oxides in the exhaust gas and residual ammonia, can be markedly decreased by applying an ammonia decomposing denitration catalyst to the denitration device 13. When the lime slurry is supplied to dilute sulfuric acid to precipitate gypsum, the quality of gypsum can be improved.

According to the exhaust gas treatment system of the present embodiment, as described above, dust in the high temperature exhaust gas is caught by the high temperature dry electrostatic precipitator 12, and nitrogen oxides NOₓ in the exhaust gas are removed by the denitration device 13. Then, the exhaust gas is cooled by the air heater 14, whereafter the exhaust gas is passed through the activated carbon fiber layer of the ACF desulfurization device 16 to remove sulfur oxides SO₂ and SO₃ contained in the exhaust gas.

As noted above, the ACF desulfurization device 16 removes sulfur dioxide SO₂ and sulfur trioxide SO₃ in the exhaust gas. Thus, it is not necessary to add ammonia to the exhaust gas, thereby converting sulfur trioxide, contained in the exhaust gas, into ammonium sulfate, and to remove the resulting ammonium sulfate by the electrostatic precipitator 12. Hence, ammonia for desulfurization treatment is not required, so that the cost of treatment can be decreased. Moreover, dust in the exhaust gas can be reliably attracted and removed by the electrostatic precipitator 12. Furthermore, an influx of dust and trace metal elements into the denitration device 13 can be decreased, so that their deposition on the denitration device 13 can be prevented, and the denitration device 13 can be made compact. Besides, sulfur dioxide SO₂ and sulfur trioxide SO₃ in the exhaust gas can be removed by the activated carbon treatment means, thus obviating the need for a wet electrostatic precipitator, and making downsizing of the system possible.

The high temperature exhaust gas discharged from the boiler 11 is first freed of fine particles of dust contained therein, and is then denitrated and desulfurized. In other words, treatments for removing nitrogen oxides and sulfur oxides in the exhaust gas are performed in a situation where virtually no dust exists in the exhaust gas. Thus, the efficiency of the treatments can be increased.

In addition, dust in the high temperature exhaust gas is removed by the electrostatic precipitator 12, then nitrogen oxides in the high temperature exhaust gas are removed by the denitration device 13, then the temperature of the exhaust gas is lowered by the air heater 14, and then sulfur oxides are removed by the ACF desulfurization device 16. As noted here, denitration treatment is performed for the exhaust gas in a high temperature condition. Thus, the efficiency of treatment can be increased.

While the present invention has been described in the foregoing fashion, it is to be understood that the invention is not limited thereby, but may be varied in many other ways. For example, in the above-mentioned embodiment, the high temperature dry electrostatic precipitator 12, the denitration device 13, and the air heater 14 are successively disposed on the exit side of the boiler 11. However, the boiler 11, the high temperature dry electrostatic precipitator 12, the air heater 14, and the denitration device 13 may be disposed in this order, and the denitration device 13 may be omitted, if desired. Such variations are not to be regarded as a departure from the spirit and scope of the invention, and all such modifications as would be obvious to one skilled in the art are intended to be included within the scope of the appended claims.

1. An exhaust gas treatment system comprising:
an electrostatic precipitator for catching fine particles in a high temperature exhaust gas;
a heat exchanger provided downstream from said electrostatic precipitator; and
activated carbon treatment means for passing therethrough the exhaust gas, which has been cooled to a predetermined temperature or lower upon heat exchange by said heat exchanger after catching of the fine particles by said electrostatic precipitator, to remove sulfur oxides by an activated carbon fiber layer.

2. The exhaust gas treatment system according to claim 1, wherein denitration means for treating nitrogen oxides in the exhaust gas is provided between said electrostatic precipitator and said activated carbon treatment means.

3. The exhaust gas treatment system according to claim 2, wherein said denitration means comprises a first denitration catalyst layer, an ammonia decomposing catalyst layer, and a second denitration catalyst layer disposed in a direction of flow, and said denitration means is an ammonia decomposing denitration catalyst which adds ammonia, in an amount not smaller than an ammonia-reactive amount of the nitrogen oxides in the exhaust gas, to an entrance to said first denitration catalyst layer.

4. The exhaust gas treatment system according to claim 1, wherein said electrostatic precipitator is a high temperature dry electrostatic precipitator for catching the fine particles in the high temperature exhaust gas at 200° C. or higher.

5. The exhaust gas treatment system according to claim 1, wherein said high temperature exhaust gas is an exhaust gas discharged from a boiler plant using a fuel having a high sulfur content.
